(19) United States
(12) Patent Application Publication
(10) Pub. No.: US 2006/0189783 A1
(43) Pub. Date: Aug. 24, 2006

(54) Method for adding raw materials during the production of polyesters or copolyesters

(76) Inventors: Stefan Deiss, Harxheim (DE); Klaus Kirsten, Mainz (DE); Lutz Janko, Erzhausen (DE); Maik Rau, Frankfurt (DE)

Correspondence Address: MICHAEL BEST & FRIEDRICH, LLP, 100 E WISCONSIN AVENUE, MILWAUKEE, WI, 53202, US

(21) Appl. No.: 10/543,180

(22) PCT Filed: Jan. 13, 2004
(86) PCT No.: PCT/EP04/00159

§ 371 Date: Jan. 5, 2006

(30) Foreign Application Priority Data
Jan. 23, 2003 (DE) 103 02 535.9

(51) Int. Cl. C08G 63/02

(52) U.S. Cl. 528/272

(57) ABSTRACT

The invention relates to a method for the manufacture of polyester or copolyester without the application of a weighing machine for dosing the solid principal raw material, dicarboxylic acid, and an appropriate concept for the closed-loop control of the molar ratio of the paste prepared from the starting materials without the direct measurement of the mass flow of the solid principal raw material, dicarboxylic acid, by weighing. In addition, an indirect method for the determination of the raw material consumption without direct weighing of the solid raw material is suggested.

The invention relates to a method for the production of a paste for the manufacture of a polyester from solid and liquid raw materials and, where applicable, from additives with simplified charging of raw materials and a concept for the control of the molar ratio of the starting materials. In addition, an indirect method for the determination of the raw material consumption during the polyester manufacture is suggested.

For the purpose of this invention, the term “polyester” covers homopolyesters and/or copolyesters. The term raw materials covers the two monomers, dicarboxylic acid and bifunctional alcohol. For example, catalysers, inhibitors and, for the manufacture of copolyesters, comonomers, such as dicarboxylic acids and bifunctional alcohols, are used as additives. The entirety of raw materials and additives used for the polyester manufacture are designated as the starting materials. Paste is defined as a pumpable suspension which contains the major proportion of starting materials used during the polyester manufacture.

Methods for manufacturing polyesters are known. Conventionally, the raw materials are first transformed in an esterification reaction to a hydroxyalkyl dicarboxylic acid monomer or oligomer mixture which in the following is also designated as partially esterified oligomer. This partially esterified oligomer is then subjected to a preliminary or prepolymer condensation, whereby a prepolymer and condensation products or reaction gas, mainly bifunctional alcohols and water, are obtained. This prepolymer is then subjected to polycondensation in order to set the degree of polymerisation of the polyester to the desired level.

To ensure the process stability and a high product quality, the setting and maintenance of the desired concentration of the starting materials required for the manufacture of the polyester are of crucial importance. Here, of particular interest is the ratio of the hydroxyl end groups present, e.g. the bifunctional alcohol, to the carboxyl end groups, e.g. the dicarboxylic acid, because they represent the main reaction partners. This ratio is normally termed the molar ratio.

Since with the manufacture of the polyester the polymer is principally produced by progressive growth reactions, the ratio of the participating reactive end groups to one another is a decisive measure of the concentration of the reaction partners and therefore of decisive importance for the reaction speed and the reaction equilibria. For the purpose of the manufacture of high quality polyester it is therefore very important to maintain this molar ratio to a precisely required value.

In conventional processes for the manufacture of polyesters a pumpable paste, which is fed to the later process, is manufactured from the raw materials dicarboxylic acid and bifunctional alcohol. In addition, additives, which result in special product properties and/or a desired process behaviour, are fed to the paste and/or a later process stage.

This paste exhibits a certain molar ratio which is set and maintained at the required value with the aid of control systems. For this purpose the starting materials are normally added, in dependence of a starting material, generally dicarboxylic acid, the charging rate of which acts as a reference variable, to the paste composition system such that the desired molar ratio and the concentration of the additives are maintained. Monitoring of the set paste composition, in particular of the molar ratio, normally occurs here off-line by laboratory examinations of samples extracted from the paste at intervals of a number of hours. The exact determination of the amount of solid starting materials, primarily of dicarboxylic acid, occurs in contrast in the previously known methods by weighing the powder raw material before addition to the process. The weighing machines required for this are very expensive and need regular maintenance. In order to avoid gaps in production a suitably large reserve of paste must be held for bridging maintenance periods or standby equipment for dosing and weighing the solid dicarboxylic acid must be made available. Both variants demand high investment costs for large paste reserve containers or for standby equipment.

To ensure product quality and for the determination of the consumption of raw materials, the precise determination of the amounts of starting materials needed for manufacturing the polyester is important. In this respect, the raw materials dicarboxylic acid or its esters and bifunctional alcohol are of interest, because in terms of quantity they represent the main constituents. The precise determination of the consumption of the starting materials used in liquid form occurs with conventional mass flow measurement instruments for liquids. The precise determination of the amount of solid starting materials, primarily of dicarboxylic acid, occurs in contrast in the previously known methods by weighing the powder raw material before addition to the process. The amount of a starting material required for a certain amount of the polyester end product is designated as its raw material consumption. The designation is generally stated as a specific consumption as the ratio of the mass of the starting material referred to the mass of the polyester manufactured with it.

When a weighing machine is used, temporal changes in the measurements of the solid material mass flow occur. This so-called drift in the measured mass flow is caused by a gradual movement of the zero-point in weighing due to increasing deposits on the measurement instrument which are mainly caused by a slight residual moisture content in the solid and cannot be avoided in practice. In conventional methods this drift has only a slight effect on the process stability and the standard quality of the paste preparation. However, due to the temporally drifting mass determination inaccurate raw material consumption measurements occur. A periodic recalibration of this type of weighing machine can restrict this error, but not completely eliminate it.

The object of this invention is therefore to suggest an inexpensive and simultaneously accurate method for the improved charging of raw materials and a simplified control concept for the control of the molar ratio during the manufacture of polyesters in order to avoid the problems and disadvantages of the known methods described above.

According to the invention, this object is solved by a method for the production of a paste for the manufacture of a polyester from solid and liquid raw materials and, where applicable, from additives, characterised in that the control of the charging rate of the solid material occurs based on the deviation of the density of the finished paste measured on-line from a setpoint.

The density measurement can be made using various physical methods, such as for example according to the Coriolis principle, using ultrasound, bending vibrators, or similar. Preferably the setting of the molar ratio occurs without the use of a weighing machine for the solid raw material.

In the method according to the invention the paste density can be used as the reference variable for the close-loop control of the molar ratio. The paste density is controlled by controlling the charging rate of the solid raw material in accordance with the setpoint. The plant throughput is the reference variable for the closed-loop control of the paste discharge rate. It is regulated by controlling the corresponding handling equipment in accordance with the setpoint value. The closed-loop control of the filling level of the paste preparation container occurs by controlling the charging amount of the liquid raw material. This can also act as the reference variable for the closed-loop control of the charging rate of the additives. In addition it can be included as a disturbance variable for the closed-loop control of the charging rate of the solid material.

In a possible embodiment of this method, a maximum of 20%, preferably a maximum of 10%, of the total amount of the liquid raw material is charged between the paste preparation container and the paste density measurement.

In one embodiment of the method according to the invention the paste preparation container is only designed so large that the dwell time of the paste in the paste preparation container corresponds to the time required for an homogenisation of the starting materials.

Also the determination of the consumption of the solid raw material can occur without the use of a weighing machine.

The advantages of the method according to the invention comprise the omission of equipment which is subject to intensive maintenance and is subject to breakdown and the consequentially lower investment and maintenance costs as well as lower energy costs due to the more efficient input of the required mechanical energy for the homogenisation of the starting materials.

Furthermore, due to the shorter dwell period in the paste preparation container, a shorter system dead time is achieved, which, for example, is important with changes in the recipe. The controlled charging of the partial flow of the liquid raw material improves the standard quality and therefore also the process control due to the on-line measurement of the paste density and the on-line determination of the molar ratio compared to the previous laboratory analyses at intervals of many hours or at daily intervals. Consequently, a higher process stability during the polyester manufacture is achieved.

Further advantages compared to conventional methods arise from the direct addition of hot recycled liquid raw material to the paste with the simultaneous increase of the molar ratio set for the paste and the corresponding reduction of the molar ratio of the charging of the liquid raw material in the rest of the process sequence. This reduces energy losses and facilitates the manufacture of a low viscosity paste (<3 Pa*s) with a temperature above 75° C. From this, there is the further advantage of the increased reactivity of the raw materials in the following process stage due to a more homogeneous distribution in the reaction space and longer contact periods compared to the separate charging of a large part of the liquid raw material in the following process stage.

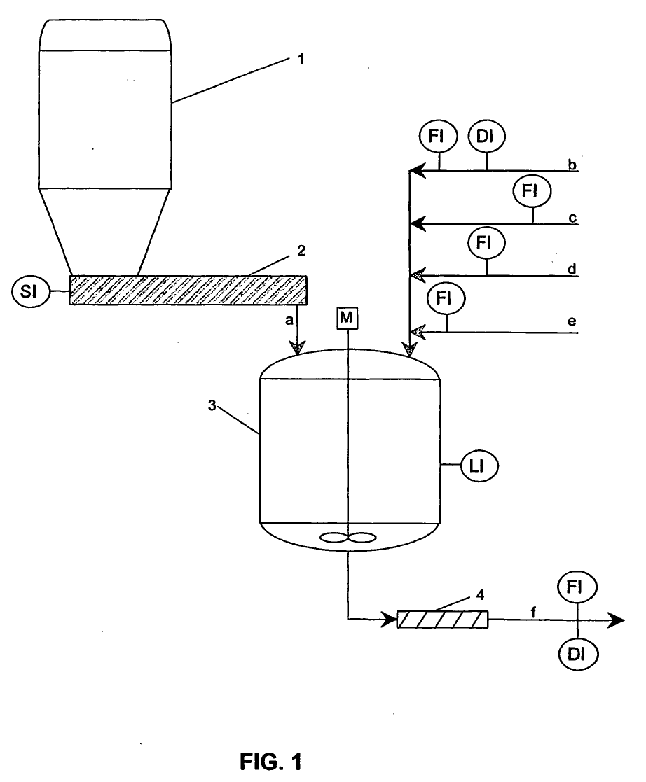

The invention is described in more detail in the following: FIG. 1 shows a possible process schematic diagram for a plant for carrying out the method according to the invention. The paste (f) containing the starting materials is prepared in the paste preparation container (3). Additionally, the raw material dicarboxylic acid (a), generally PTA, is fed from a storage silo (1) with the aid of a feeding device (2), e.g. a rotary valve feeder, feed screw, or similar, to the paste preparation container (3). The second raw material, bifunctional alcohol (b), is added together with all other additives (c), (d), (e) under measurement of the mass flow (FI) to the paste preparation container (3). Here, the number of other additives to the paste preparation container (3) is not restricted to the three stated here, but rather only depends on the requirements of the desired end product. For the purpose of the method according to the invention, it does not matter in which manner the starting materials are added to the paste preparation container (3). It is decisive that the mass flow is determined of all starting materials which are added along with the solid dicarboxylic acid (a) to the paste preparation container (3). Here it does not matter whether the mass flow measurement is carried out for each individual flow (c)-(e) or a mixture of various additives, provided the quantities crucial for the molar ratio are acquired. The paste (g) manufactured in the paste preparation container (3) is passed for further application to the process for polyester manufacture with the aid of at least one pump (4). Here, the amount of paste (f) supplied from the paste preparation container (3) is determined by mass flow measurement (FI). In addition the paste density (DI) is determined. For the closed-loop control of the molar ratio according to the method of the invention, it is important to determine the amount of bifunctional alcohol and all other additives as well as the paste density on-line.

The amount of the raw material, bifunctional alcohol, is the reference variable in the closed-loop control concept according to the invention. It is set to the desired value or controlled to the desired value by another closed-loop control.

The amount (b) is acquired on-line with a flow meter (FI). The amounts of the other additives to the paste are set or regulated according to the requirements of the polyester manufacture (recipe) in order to maintain the desired concentrations of the additives. The amounts of the additive flows are also acquired with the aid of flow measurement instruments (FI). With knowledge of the above mentioned quantities and the composition of the material flows (from the recipe and known quasi-constant contaminants), the required amount of dicarboxylic acid (a) can be calculated which is necessary for setting the desired molar ratio. Based on this quantity, the setpoint value is specified for the speed controller for the feed device (2). Since the speed device does not fulfil any accurate measurement task or dosing function, the signal of the density (DI) of the paste (f) is required. The paste density is also passed as disturbance variable to the speed controller of the feed device (2) in order to influence it such that the fed amount is increased when the paste density drops below the value demanded for the required molar ratio and vice versa appropriately.

Compared to conventional control concepts which require the direct weighing of the solid raw material, this method has the advantage that the weighing machine for charging the solid raw material can be omitted. Additionally, due to the on-line measurement of the paste density, the standard quality is improved and the process stability is better ensured, because due to the direct measurement of the paste density, the molar ratio being used is monitored on-line and controlled, whereas in conventional methods the monitoring only occurs through off-line laboratory analyses of samples taken at intervals of many hours.

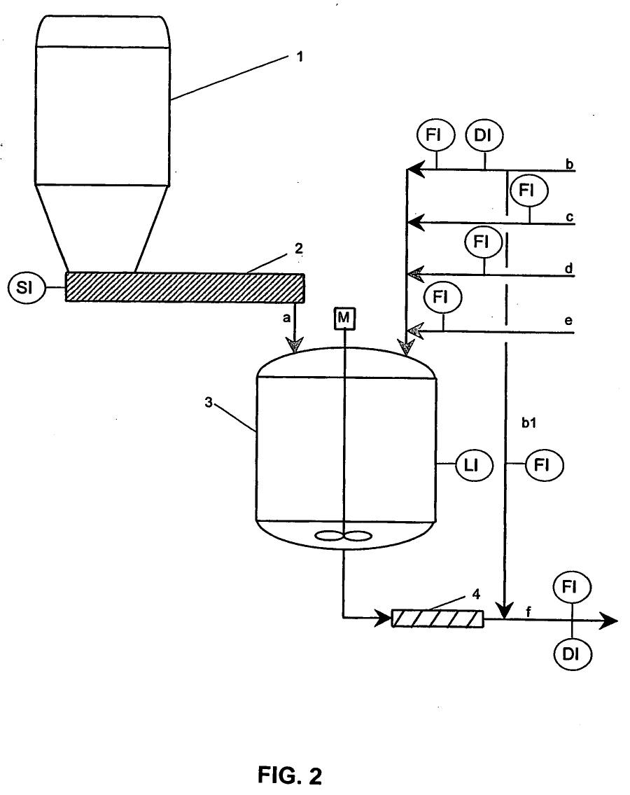

To improve the standard quality still further, it is practicable to also measure, as well as the mass flow, the density of the raw material, bifunctional alcohol (b), on-line. It is then easier to take into account any density variations in the raw material which occur due to contaminants, e.g. water. This is of special significance when the raw material, bifunctional alcohol, is taken as a recycled product with possible slight quality variations from the following method for polyester manufacture. Another variant of the method for improving the process stability is shown in FIG. 2. Here, variations still present in the paste density, resulting for example from system dead time of the closed-loop control circuit are rectified by the controlled addition of a small partial flow of the raw material, bifunctional alcohol (b1≦10% of b), to the paste (f) with the objective of a fine correction of any remaining control deviations. Consequently, the constancy of the molar ratio to be controlled can be increased still further, leading to an improved process stability and product quality.

The control of the required amount of the raw material, bifunctional alcohol (b), can occur with the aid of the filling level controller (LI) of the paste preparation container (3) in order to maintain a desired filling level in the paste preparation container. Here, when the filling level is too low, the added amount of raw material, bifunctional alcohol (b), is increased and vice versa appropriately.

The amount of the supplied paste (f) can be influenced by the filling level controller of the next container and is also used as the master signal for the flow control of the complete plant for polyester manufacture. In the method according to the invention no weighing machine is used for the direct mass acquisition of the raw material, dicarboxylic acid. Therefore, the following method is suggested for the indirect determination of the consumption of raw material. The sought raw material consumption of the solid raw material, dicarboxylic acid (a) is found with the aid of the measured mass flows (FI) and the known content of the paste preparation container (3) (LI) as well as the known density of the paste (f) (D) at the start and at the end of the observed time interval according to the method according to the invention as follows:

$${m}_{a}^{s} = \frac{A \cdot ( {ρ}_{2} - {ρ}_{1} ) + B \cdot ( {ρ}_{2} \cdot {L}_{2} - {ρ}_{1} \cdot {L}_{1} ) + {m}_{f} - {\sum }_{k} {m}_{k}}{Δ t \cdot D \cdot ( 1 + \frac{A \cdot ( {ρ}_{2} - {ρ}_{1} ) + B ( {ρ}_{2} \cdot {L}_{2} - {ρ}_{1} \cdot {L}_{1} )}{{m}_{f}} )} \cdot 1000 \qquad ( 1 )$$

where:
mₐ^{s}—specific mass consumption of the solid raw material (a) in the observed time interval Δt in kg (a)/t of product
Δt=(t2−t1)—time interval for which the raw material consumption is to be determined in h
t1, t2—start and end time of the time interval Δt for the determination of the raw material consumption
A, B—constants specific to the plant
ρ₁, ρ₂—measured density of the paste (f) at time t1 or t2 in kg/m³
L₁, L₂—measured filling level in the paste preparation container (3) at time t1 or t2 in %
m_{f}—measured accumulated mass of the paste (f) which has been supplied in the time interval Δt from the paste preparation container (3) in kg
mₖ—measured accumulated mass of all other starting materials with k=b; c; d; e, which have been added in the time interval Δt to the paste preparation container (3) in kg
D—throughput of the plant in kg of product (polyester)/h

For the scope of application of the method it is advantageous if the throughput of the plant for polyester manufacture is constant in the time period for the determination of the raw material consumption. If this cannot be ensured, the plant throughput can be determined in another manner during the consumption measurement, for example through the complete quantitative acquisition of the end product during this time period.

Due to the high accuracy of the measurement equipment for mass flow and density determination, it can be proven that the accuracy achieved in the raw material determination in conventional methods using a weighing machine can be exceeded with the method according to the invention.

Compared to conventional methods, the method of indirect solid material determination according to the invention has the further advantage in that the temporal changes in the measurements of the solid material mass flow (drift), as observed with weighing, do not occur. Due to the high long-term stability and reliability of the measurement method used with the indirect mass determination of the solid material according to the invention, the raw material consumption measurement is stable and reliable also over long observed time periods, which represents a decisive advantage compared to conventional methods.

From the method according to the invention for the charging of the solid raw material, dicarboxylic acid (a), during polyester manufacture without the use of a weighing machine a further decisive advantage arises compared to conventional methods in that the storage of the paste in the paste preparation container for bridging faults or maintenance periods on the weighing unit can be significantly reduced. This is facilitated by the application of low-maintenance measurement instruments which do not contain any mechanically moving parts. For the remaining mechanically moving parts, for example feed devices (screws, tubular chain conveyors, etc.), standby equipment can be made available if required to further minimise possible downtimes with faults or maintenance. Due to the minimum container volume attainable for the paste preparation container, then in the method according to the invention, apart from the investment costs, also the dead time of the paste preparation system can be substantially reduced. This in turn has a positive effect on the standard quality of the paste preparation and the process stability and consequently also on the product quality.

The applicability of the method according to the invention is now explained based on examples.

### EXAMPLE 1

For the manufacture of 10000 kg/h of polyethylene terephthalate copolyester the raw material consumption of the terephthalic acid is determined over 3 days (72 h). The following accumulated measurement results are available for the starting materials fed to the paste preparation container and the paste supplied in 72 h:

| | | |
|---|---|---|
| Isophthalic acid | m_{IPA} | 12 |
| Ethylene glycol | m_{EG} | 2393 |
| Diethylene glycol | m_{DEG} | |
| Catalyser solution | m_{CAT} | 17 |
| Paste | m_{f} | 8780 |
| Paste density 1 | ρ₁ | 1391.3 |
| Paste density 2 | ρ₂ | 1390.7 |
| Level 1 | L₁ | |
| Level 2 | L₂ | |
| Constant A | A | [symbol] |
| Constant B | B | 0.3 |

The following PTA consumption is found by applying Equation (1):

$${m}_{a}^{s} = \frac{A \cdot ( {ρ}_{2} - {ρ}_{1} ) + B \cdot ( {ρ}_{2} \cdot {L}_{2} - {ρ}_{1} \cdot {L}_{1} ) + {m}_{f} - {\sum }_{k} {m}_{k}}{Δ t \cdot D \cdot ( 1 + \frac{A \cdot ( {ρ}_{2} - {ρ}_{1} ) + B ( {ρ}_{2} \cdot {L}_{2} - {ρ}_{1} \cdot {L}_{1} )}{{m}_{f}} )} \cdot 1000$$

$${m}_{a}^{s} = \frac{\begin{matrix}6.8361 \cdot ( 1390.7 - 1391.3 ) + \\ 0.36988 \cdot ( 1390.7 \cdot 80.1 - 1391.3 \cdot 80.0 ) + 878016 - 272119\end{matrix}}{72 \cdot 10000 \cdot ( 1 + \frac{\begin{matrix}6.8361 \cdot ( 1390.7 - 1391.3 ) + \\ 0.36988 \cdot ( 1390.7 \cdot 80.1 - 1391.3 \cdot 80.0 )\end{matrix}}{878016} )} \cdot 10000$$

$${m}_{a}^{s} = 841.5 kg of PTA \text{/} t of PET .$$

The mass flow measurement and accumulation of the liquid starting materials and the paste occurred with the aid of measurement equipment operating on the Coriolis principle. The IPA amount was measured with a weighing machine.

### EXAMPLE 2

For the manufacture of 5000 kg/h of polyethylene terephthalate homopolyester the raw material consumption of the terephthalic acid is determined over 8 hours. The following accumulated measurement results are available for the starting materials fed to the paste preparation container and the paste supplied in 8 hours:

| | | |
|---|---|---|
| Ethylene glycol | m_{EG} | 14 |
| Catalyser solution | m_{CAT} | |
| Paste | m_{f} | 48 |
| Paste density 1 | ρ₁ | 1390.5 |
| Paste density 2 | ρ₂ | 1391.1 |
| Level 1 | L₁ | |
| Level 2 | L₂ | |
| Constant A | A | 0.0 |
| Constant B | B | 0.1 |

The following PTA consumption is found by applying Equation (1):

$${m}_{a}^{s} = \frac{A \cdot ( {ρ}_{2} - {ρ}_{1} ) + B \cdot ( {ρ}_{2} \cdot {L}_{2} - {ρ}_{1} \cdot {L}_{1} ) + {m}_{f} - {\sum }_{k} {m}_{k}}{Δ t \cdot D \cdot ( 1 + \frac{A \cdot ( {ρ}_{2} - {ρ}_{1} ) + B ( {ρ}_{2} \cdot {L}_{2} - {ρ}_{1} \cdot {L}_{1} )}{{m}_{f}} )} \cdot 1000$$

$${m}_{a}^{s} = \frac{\begin{matrix}0.01086 \cdot ( 1391.1 - 1390.5 ) + \\ 0.14362 \cdot ( 1391.1 \cdot 70.0 - 1390.5 \cdot 50.0 ) + 48780 - 15542\end{matrix}}{8 \cdot 5000 \cdot ( 1 + \frac{\begin{matrix}0.01086 \cdot ( 1391.1 - 1390.5 ) + \\ 0.14362 \cdot ( 1391.1 \cdot 70.0 - 1390.5 \cdot 50.0 )\end{matrix}}{48780} )} \cdot 10000$$

$${m}_{a}^{s} = 860.4 kg of PTA \text{/} t of PET .$$

The mass flow measurement and accumulation of the liquid starting materials and the paste occurred with the aid of measurement equipment operating on the Coriolis principle.

1. Method for the production of a paste for the manufacture of a polyester from solid and liquid raw materials and, where applicable, from additives, characterised in that the closed-loop control of the charging rate of the solid raw material occurs based on the deviation of the density of the prepared paste from a setpoint value.

2. Method according to claim 1, whereby the setting of the molar ratio occurs without the application of a weighing machine for the solid raw material.

3. Method according to claim 1, whereby the density of the paste is used as the reference variable for the closed-loop control of the molar ratio.

4. Method according to claim 1, whereby both the mass flow and also the density of the liquid raw material are measured on-line.

5. Method according to claim 1, whereby a maximum of 20%, preferably a maximum of 10%, of the total amount of the liquid raw material is added after the paste preparation container and before the paste density measurement.

6. Method according to claim 1, whereby the charging of the liquid raw materials and additives occurs by measurement of their mass flows.

7. Method according to claim 1, whereby the closed-loop control of the liquid raw material (b-b 1) occurs by measurement of the filling level of the paste preparation container.

8. Method according to claim 1, whereby the determination of the consumption of the solid raw material occurs without the application of a weighing machine.
